(19) United States
(12) Patent Application Publication
(10) Pub. No.: US 2012/0247250 A1
(43) Pub. Date: Oct. 4, 2012

(54) GEARBOX AND OIL SPREADER THEREOF

(75) Inventors: Apostolos Pavlos Karafillis, Lynn, MA (US); Justin Paul Pare, Hooksett, NH (US); Niranjan Patel, Lynnfield, MA (US); Brian Devendorf, Swampscott, MA (US)

(73) Assignee: GENERAL ELECTRIC COMPANY, Schenectady, NY (US)

(21) Appl. No.: 13/077,205

(22) Filed: Mar. 31, 2011

(51) Int. Cl. F16H 57/04; F16H 57/02

(52) U.S. Cl. 74/467; 74/606 R

(57) ABSTRACT

An oil spreader for a gearbox includes: an annular body with a central axis, opposed upper and lower ends, an upper portion adjacent the upper end, and a lower portion adjacent the lower end, the lower portion comprising at least two vanes extending between the upper portion and an annular ring disposed at the lower end, the vanes defining slots therebetween.

### BACKGROUND OF THE INVENTION

This invention relates generally to gearboxes and more particularly to control of oil flow in gearboxes for gas turbine engines.

A gas turbine engine usually includes one or more mechanically-driven accessories, such as fuel or oil pumps, generators or alternators, control units, and the like. Such accessories are mounted to an accessory gearbox (“AGB”) which extracts torque from the engine, and drives each accessory at the required rotational speed, using an internal gear train.

Pressurized oil flow is delivered to the AGB for lubrication and cooling. The spent oil from the AGB drains back to a supply and scavenging system of the engine. Because such engines are often used in aircraft, the engine's orientation (i.e. its roll and pitch angle) varies significantly during operation.

Some engine orientations can cause an excessive amount of oil draining from the AGB to flow into a bearing sump of the engine, instead of directly to an oil tank. This excessive oil inflow can exceed the capability of the supply and scavenge system to remove or scavenge oil from the sump. This in turn can cause churning or flooding of oil in the sump, which in turn can cause engine stalls. It is possible to control oil flow with devices such as baffles. However, such devices have a significant size and therefore cannot be installed without extensive disassembly of the gearbox.

Accordingly, there is a need for a compact device to control oil drain flow within a gearbox.

### BRIEF DESCRIPTION OF THE INVENTION

This need is addressed by the present invention, which provides a compact rotating oil spreader which can be mounted to a rotating shaft of a gearbox.

According to one aspect of the invention, an oil spreader for a gearbox comprises: an annular body with a central axis, opposed upper and lower ends, an upper portion adjacent the upper end, and a lower portion adjacent the lower end, the lower portion comprising an array of at least two vanes extending between the upper portion and an annular ring disposed at the lower end, the vanes defining slots therebetween

According to another aspect of the invention a gearbox comprises: a housing enclosing at least one gear; an input shaft mounted for rotation in the housing, the input shaft having a central axis, and upper and lower ends; an oil spreader attached to and surrounding a portion of the input shaft, the oil spreader comprising: an annular body having a central axis, opposed upper and lower ends, an upper portion adjacent the upper end, and a lower portion adjacent the lower end, the lower portion comprising at least two vanes extending between the upper portion and an annular ring disposed at the lower end, the vanes defining slots therebetween.

### BRIEF DESCRIPTION OF THE DRAWINGS

The invention may be best understood by reference to the following description taken in conjunction with the accompanying drawing figures in which:

FIG. 1 is a perspective view of a gas turbine engine incorporating an accessory gearbox constructed according to an aspect of the present invention;

FIG. 2 is a partially-sectioned front elevation view of an accessory gearbox in a first orientation;

FIG. 3 is a partially-sectioned front elevation view of an accessory gearbox in a second orientation;

FIG. 4 is a partially-sectioned front elevation view of the gearbox of FIG. 2 with an oil spreader constructed according to an aspect of the present invention installed therein, showing an upper bearing assembly thereof;

FIG. 5 is a partially-sectioned front elevation view of the gearbox of FIG. 2 with an oil spreader constructed according to an aspect of the present invention installed therein, showing a lower bearing assembly thereof;

FIG. 6 is a top plan view of an oil spreader constructed according to an aspect of the present invention;

FIG. 7 is a side elevation view of the oil spreader of FIG. 6;

FIG. 8 is a view taken along lines 8-8 of FIG. 7; and

FIG. 9 is a cross-sectional view of the oil spreader of FIG. 6.

### DETAILED DESCRIPTION OF THE INVENTION

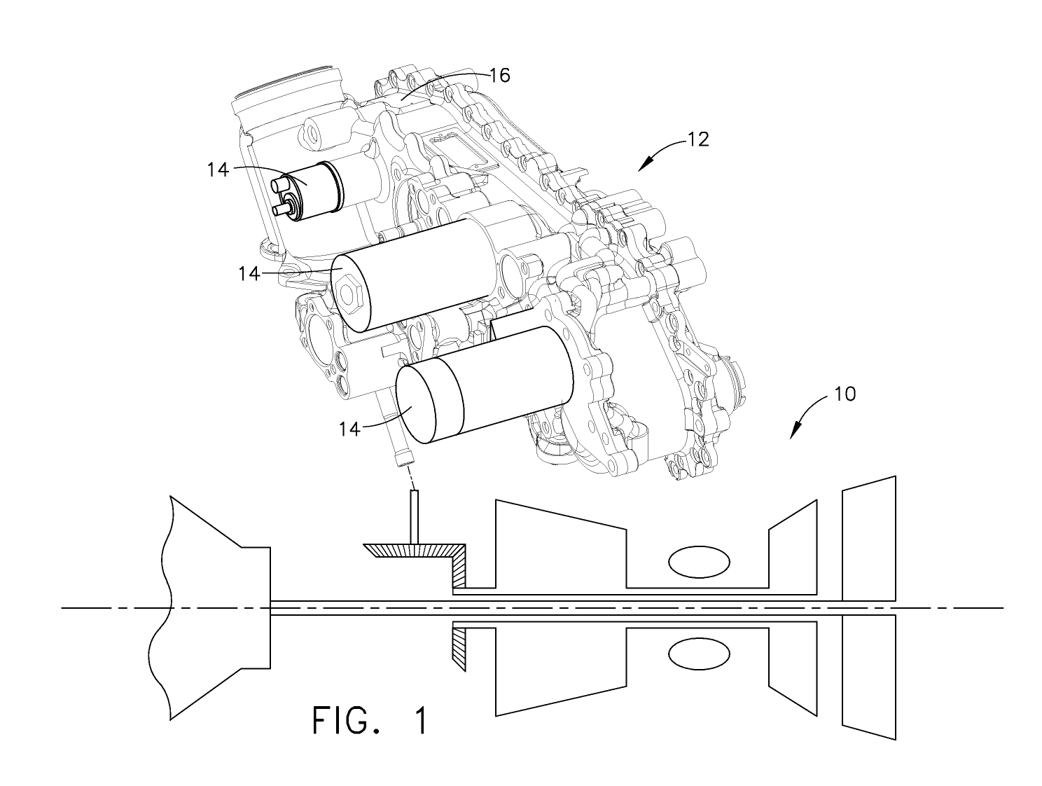

Referring to the drawings wherein identical reference numerals denote the same elements throughout the various views, FIG. 1 depicts an aircraft gas turbine engine 10. The illustrated example is a turboshaft engine, but the principles of the present invention are applicable to any type of gearbox having a circulating oil supply. The engine 10 has an accessory gearbox (“AGB”) 12 mounted to it. Various shaft-driven engine accessories (shown generally at 14), such as oil and fuel pumps, starters, generators, alternators, etc. are mounted to the AGB 12. Torque from the engine 10 is transferred through a gear train housed within the AGB 12 to drive each of the individual accessories 14.

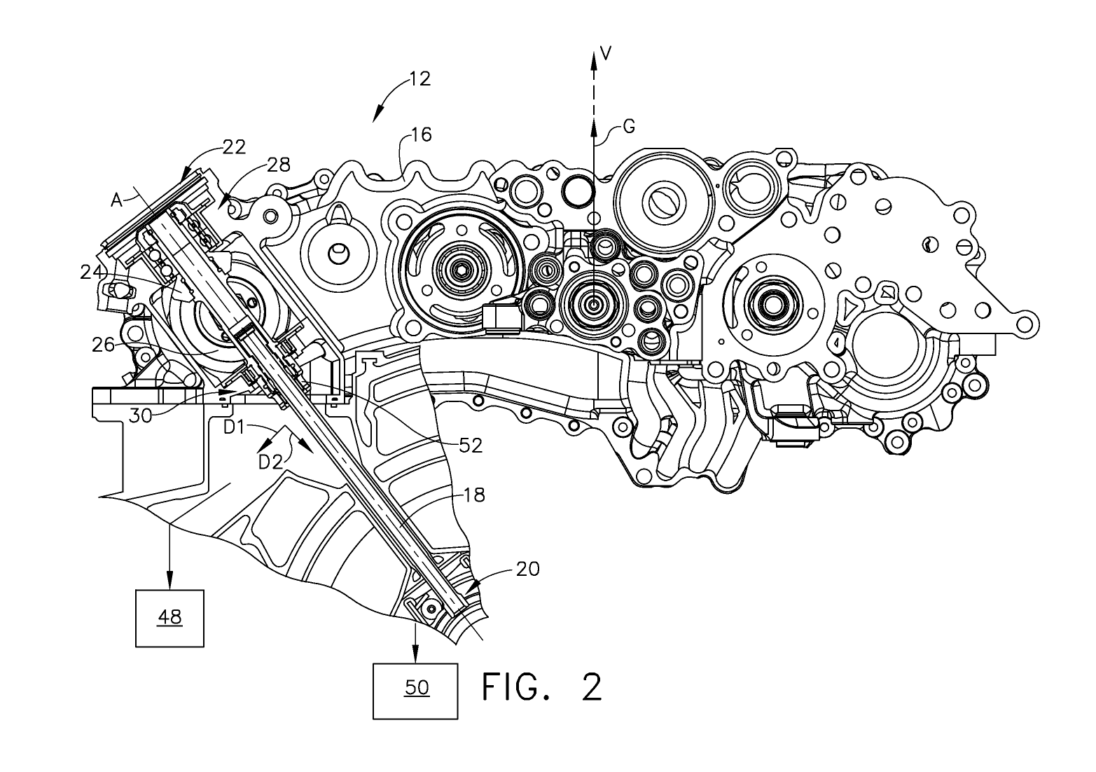

FIG. 2 is a partially cut-away view of the AGB 12. The AGB 12 has a stationary housing 16. A shaft 18, also referred to as an “A-axis shaft”, is mounted in the housing 16 and extends along a radial axis (labeled “A”) that intersects the longitudinal centerline axis of the engine 10. The shaft 18 has an inner end 20 and an outer end 22. The inner end 20 is engaged with a drive gear (not shown) of the engine 10. The outer end 22 carries a bevel gear 24 which engages another bevel gear 26. The bevel gear 26 is engaged with other gears (not shown) within the housing 16. The gears are configured in a known manner to drive multiple output shafts at the speeds and directions needed for the various accessories 14 (shown in FIG. 1).

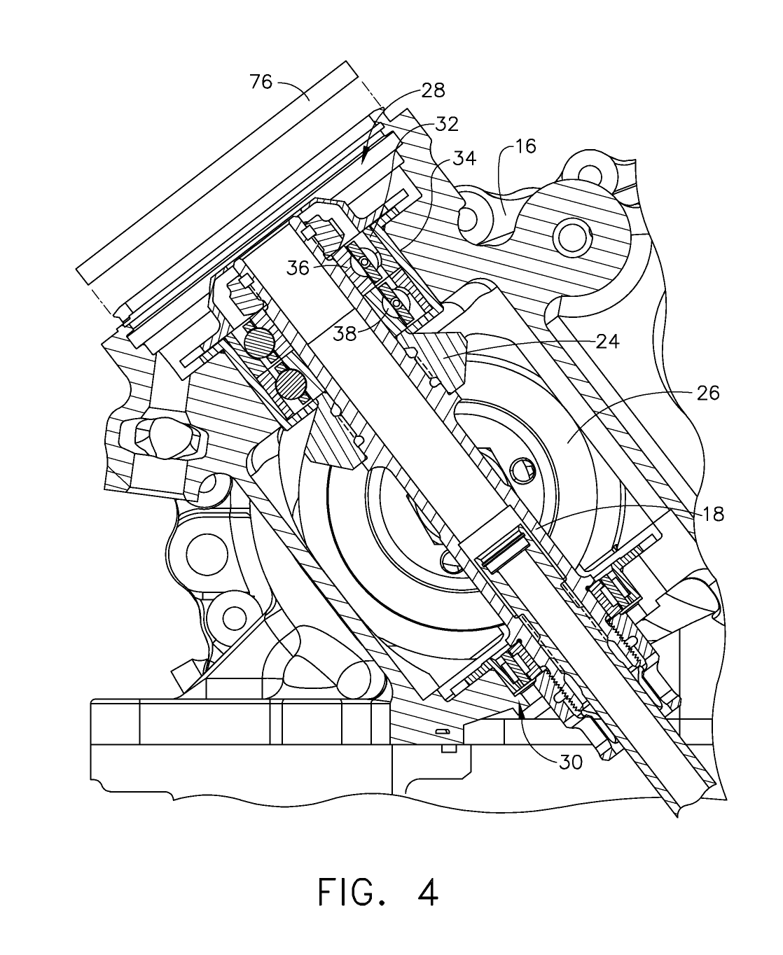

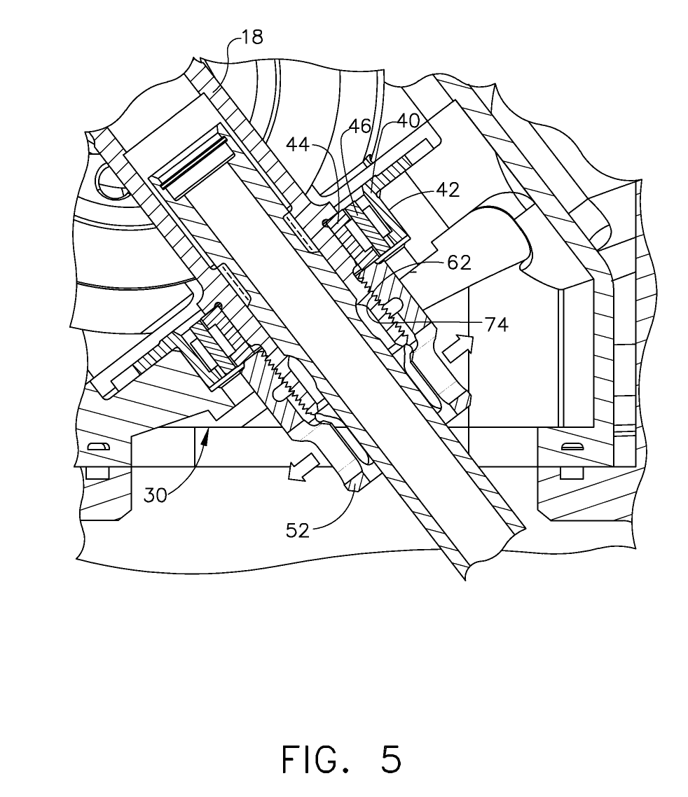

FIGS. 4 and 5 show in more detail how the shaft 18 is mounted. Specifically, the shaft 18 rotates in an upper bearing assembly 28 and a lower bearing assembly 30. It is noted that, as used herein, directional terms applied to certain components (for example, “upper”, “lower”, “inner”, and “outer”) are intended for the purpose of convenient reference and description, and do not imply that any particular orientation of the component is necessary relative to the external environment.

The upper bearing assembly 28 comprises an outer race 32 received in an upper bore 34 of the housing 16, an inner race 36 fixedly attached to the shaft 18 (for example by interference fit), and a plurality of rolling elements 38 such as balls or rollers disposed between the inner and outer races 36 and 32. As used herein, the term “fixedly” means that the two components which are “fixedly attached” to each other do not experience relative movement to each other during normal operation of the AGB 12. The diameter of the upper bore 34 is selected to be greater than the maximum diameter of the bevel gear 24.

The lower bearing assembly 30 (best seen in FIG. 5) comprises an annular outer race 40 fixedly mounted to a lower bore 42 in the housing 16 (for example by interference fit), an annular inner race 44 fixedly mounted to the shaft 18 (for example by interference fit), and a plurality of rolling elements 46 such as balls or rollers disposed between the inner and outer races 44 and 40.

Referring back to FIG. 2, the interior of the housing 16, including the upper and lower bearing assemblies 28 and 30, is provided with a flow of lubricant such as petroleum-based oil for cooling and lubrication. The lubricant flow is provided by a supply and scavenging system of a known type, which is not shown. The spent oil drains vertically downward by gravity. Some of the oil drain flow (shown by arrow “D1”) passes along a first internal flow path which leads to an oil tank 48 (shown schematically in FIG. 2). The remainder of the oil drain flow (shown by arrow “D2”) runs along a second internal flow path, down the exterior of the shaft 18, and eventually into a bearing sump 50 of the engine (shown schematically in FIG. 2). The oil tank 48 and the bearing sump 50 are both part of the supply and scavenging system. FIG. 2 corresponds to conditions during level-flight operation of the engine. In this orientation, an arrow “G” representing a vertical or 12:00 o'clock direction of the AGB 12 coincides with an earth-vertical vector “V” shown. In this orientation, the proportion of the oil drain flow passing into the bearing sump 50 is within the design capacity of the supply and scavenging system to remove excess oil from the bearing sump 50.

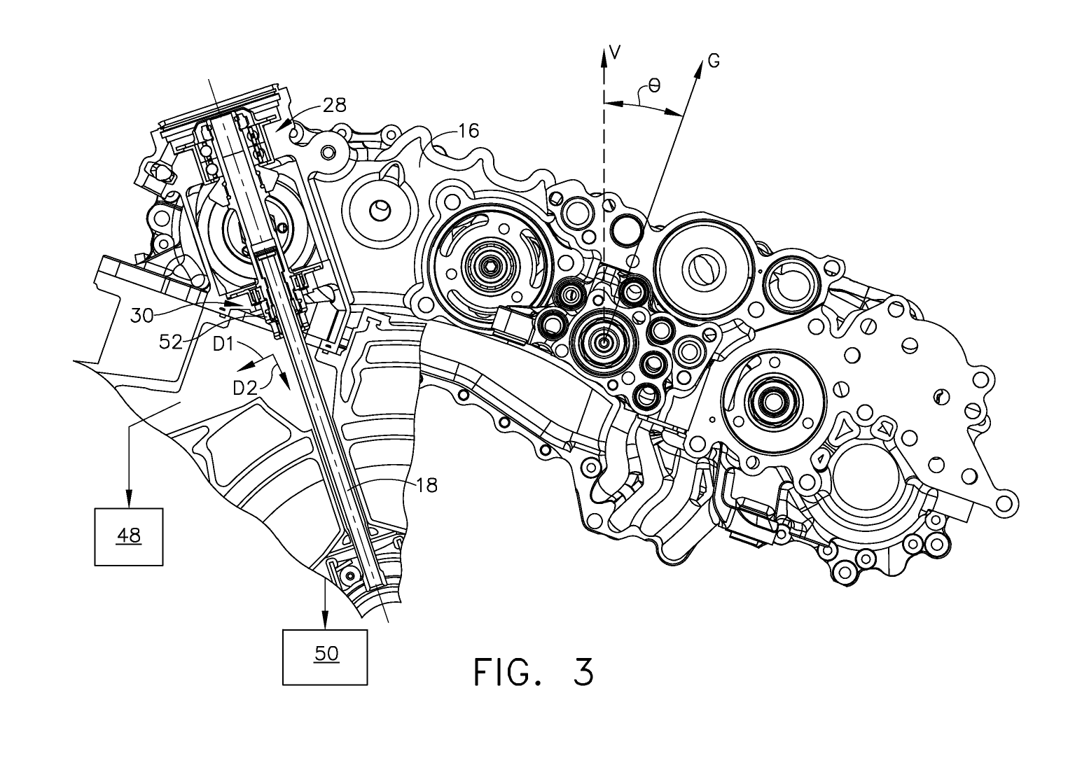

FIG. 3 corresponds to operation of the engine 10 and AGB 12 in a position rolled away from the vertical orientation. In this orientation, an arrow “G” representing a vertical or 12:00 o'clock direction of the AGB 12 defines a nonzero angle θ with an earth-vertical vector V. In this orientation, a greater proportion of the oil drain flow D2 passes down along the shaft 18 and into the bearing sump 50 than when then engine 10 is in a vertical orientation. Under some circumstances this flow can exceed the scavenging ability of the bearing sump 50, leading to oil churning and/or flooding, and possibly causing engine stalls.

To prevent undesired oil drain flow in to the bearing sump 50, the AGB is provided with an oil spreader 52 (seen in FIG. 5) which is attached to the shaft 18 just below the lower bearing assembly 30.

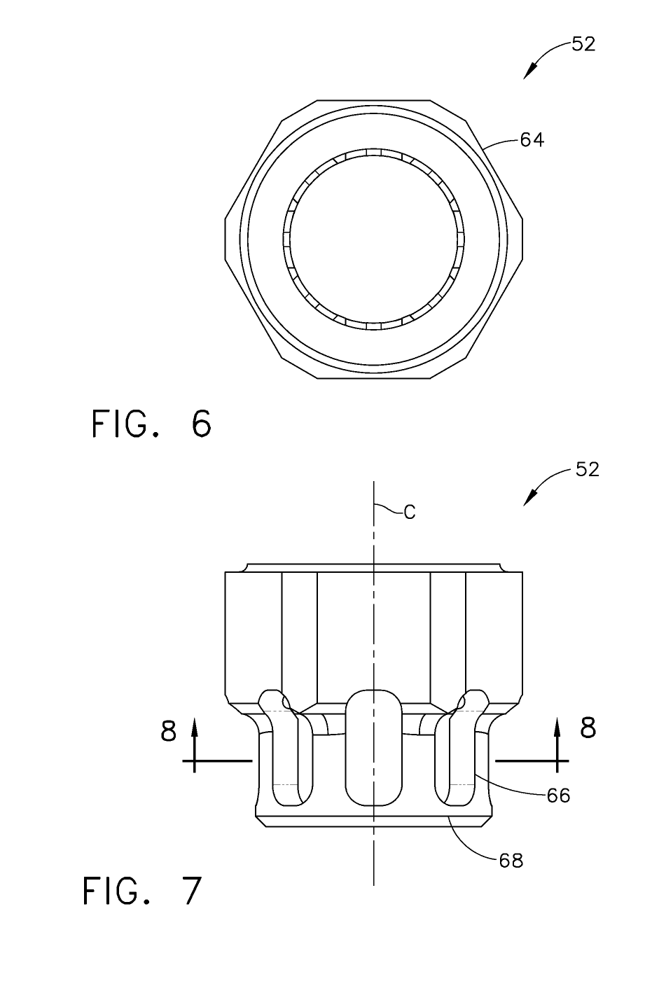

FIGS. 6-9 illustrate the oil spreader 52 in more detail. The oil spreader has an annular body (generally in the shape of a hollow cylinder) with a central axis “C”, an upper end 54, and a lower end 56. As illustrated it is a single integral component made from a metal alloy, but it could be built up from smaller components. It is roughly divided into an upper portion 58 and a lower portion 60. The interior of the upper portion 58 is provided with female threads 62, and the exterior may be formed into wrenching flats 64, i.e. planar surfaces arranged in a hexagon or other shape to facilitate installation and removal of the oil spreader 52 using a wrench, spanner, or other similar tool. The maximum outer diameter of the oil spreader 52 is less than the inside diameter of the outer race 40 of the lower bearing assembly 30.

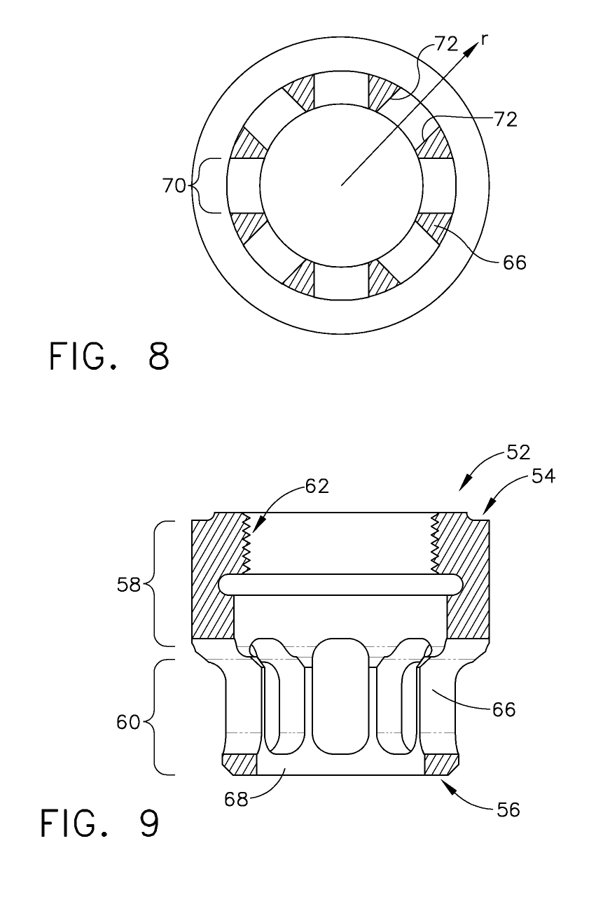

An annular array of circumferentially spaced-apart vanes 66 extend in a generally axial direction between the upper portion 58 and a ring 68 located at the lower end 56. The ring 68 interconnects the distal ends of the vanes 66. Open slots 70 are defined between the sidewalls 72 of each pair of adjacent vanes 66. The vanes 66 are configured so as to function as a centrifugal pump and effectively create a radially outward air flow when the oil spreader 52 rotates about its central axis C. In the illustrated example, each of the vanes 66 is defined in part by two sidewalls 72 oriented at an oblique angle to each other, creating a wedge-shaped in cross-section. The sidewalls 72 of adjacent vanes 66 are aligned parallel to a radial direction, denoted “r” in FIG. 8. Depending on the particular application, the vanes 66 may have a different cross-sectional shape or may be turned at a different angle relative to the radial direction r in order to provide an effective air flow. The number and size of the vanes 66 may also be varied to suit a particular application.

The oil spreader 52 is shown installed in FIG. 5. The female threads 62 engage mating male threads 74 of the shaft 18, and the oil spreader 52 is screwed into position abutting the inner race 44 of the lower bearing assembly 30. The oil spreader 52 may be installed without disassembling or removing the AGB 12 from the engine 10. To accomplish this, a cover 76 (seen in FIG. 4) is removed and the shaft 18 is withdrawn from the AGB 12. The oil spreader 52 is then threaded onto the shaft 18. The shaft 18 is then reinserted. Because the outer diameter of the oil spreader 52 is less than the inside diameter of the outer race 40, it is able to pass therethrough without interference. Finally the cover 76 is replaced.

In operation, the rotating oil spreader 52 generates a radially outward flow of air, in the manner of a centrifugal pump. This flow of air (shown schematically by the block arrows in FIG. 5) entrains oil and directs it away from the shaft 18 and the flowpath to the bearing sump 50, and towards the oil tank 48 (seen in FIG. 3). This ensures that the flow rate of oil into the bearing sump 50 is not excessive regardless of the orientation of the AGB 12.

The oil spreader described herein has several advantages as compared to prior art configurations. It can be both a production component and a field retrofit. It is inexpensive and in the case of a field retrofit, it does not require removal of the AGB 12, as the shaft 18 can be removed and reinstalled while the AGB 12 remains installed on the engine 10. This represents a significant savings in time, effort, and cost compared to other means for controlling oil flow.

The foregoing has described an oil spreader for a gearbox. While specific embodiments of the present invention have been described, it will be apparent to those skilled in the art that various modifications thereto can be made without departing from the spirit and scope of the invention. Accordingly, the foregoing description of the preferred embodiment of the invention and the best mode for practicing the invention are provided for the purpose of illustration only and not for the purpose of limitation, the invention being defined by the claims.

What is claimed is:

1. An oil spreader for a gearbox, comprising: an annular body with a central axis, opposed upper and lower ends, an upper portion adjacent the upper end, and a lower portion adjacent the lower end, the lower portion comprising at least two vanes extending between the upper portion and an annular ring disposed at the lower end, the vanes defining slots therebetween.

2. The oil spreader of claim 1 wherein the lower portion comprises an array of vanes extending between the upper portion and the annular ring.

3. The oil spreader of claim 1 further comprising female threads formed on an interior surface of the upper portion.

4. The oil spreader of claim 1 wherein an exterior surface of the upper portion defines a plurality of wrenching flats.

5. The oil spreader of claim 1 wherein each of the vanes is defined in part by a pair of spaced-apart sidewalls which are disposed at an oblique angle to each other.

6. The oil spreader of claim 4 wherein the sidewalls are aligned parallel to a direction radial to the central axis.

7. The oil spreader of claim 1 wherein the lower portion comprises an annular array of eight equally spaced-apart vanes extending between the upper portion and the annular ring, wherein an open slot is defined between sidewalls of each pair of adjacent vanes.

8. A gearbox, comprising:
a housing enclosing at least one gear;
a shaft mounted for rotation in the housing, the shaft having a central axis, and upper and lower ends; and
an oil spreader attached to and surrounding a portion of the shaft, the oil spreader comprising: an annular body having a central axis, opposed upper and lower ends, an upper portion adjacent the upper end, and a lower portion adjacent the lower end, the lower portion comprising at least two vanes extending between the upper portion and an annular ring disposed at the lower end, the vanes defining slots therebetween.

9. The gearbox of claim 8 wherein the lower portion of the oil spreader comprises an annular array of eight equally spaced-apart vanes extending between the upper portion and the annular ring, wherein an open slot is defined between sidewalls of each pair of adjacent vanes.

10. The gearbox of claim 8 wherein the oil spreader is attached to the shaft by a threaded connection.

11. The gearbox of claim 8 wherein an exterior surface of the upper portion of the oil spreader defines a plurality of wrenching flats.

12. The gearbox of claim 8 wherein each of the vanes of the oil spreader is defined in part by a pair of spaced-apart sidewalls which are disposed at an oblique angle to each other.

13. The gearbox of claim 12 wherein the sidewalls are aligned parallel to a direction radial to the central axis.

14. The gearbox of claim 6 wherein the shaft is mounted to the gearbox by a lower bearing assembly and an upper bearing assembly, and the oil spreader is disposed abutting the lower bearing assembly.

15. The gearbox of claim 14 wherein the lower bearing assembly comprises:
an annular outer race fixedly mounted to a lower bore in the housing;
an annular inner race fixedly mounted to the shaft; and
a plurality of rolling elements disposed between the inner and outer races;
where a maximum outside diameter of the oil spreader is sized to pass through an inside diameter of the outer race without interference.
